(19) United States
(12) Patent Application Publication
(10) Pub. No.: US 2014/0162603 A1
(43) Pub. Date: Jun. 12, 2014

(54) METHOD OF MANAGING SERVICE MODE OF FEMTO BASE-STATION AND ACCESS ALLOWANCE FOR TERMINAL

(71) Applicant: Electronics and Telecommunications Research Institute, Daejeon (KR)

(72) Inventors: Eun Seon CHO, Daejeon (KR); Chan Yong LEE, Daejeon (KR); Hyeon Ju OH, Daejeon (KR); Byung Han RYU, Daejeon (KR); Nam Hoon PARK, Daejeon (KR)

(73) Assignee: Electronics and Telecommunications Research Institute, Daejeon (KR)

(21) Appl. No.: 13/970,044

(22) Filed: Aug. 19, 2013

(30) Foreign Application Priority Data
Dec. 6, 2012 (KR) 10-2012-0140997

(51) Int. Cl. H04W 12/08

(52) U.S. Cl. CPC H04W 12/08
USPC 455/411

(57) ABSTRACT

A method of managing a service mode of a femto cell base-station and access allowance for a terminal is disclosed. The method of managing access allowance includes receiving a first access allowance change request for a terminal, and transmitting a second access allowance change request for the terminal to a mobility management entity (MME) in response to the first access allowance change request. With the method of the example embodiments of the present invention, the service mode of the femto base-station and the access allowed terminal can be changed in real time according to a situation of the user. Accordingly, quality of service can be improved and efficient management of the femto base-station can be achieved through interference control between the macro base-station and the femto base-station.

### CLAIM FOR PRIORITY

This application claims priority to Korean Patent Application No. 10-2012-0140997 filed on Dec. 6, 2012 in the Korean Intellectual Property Office KIPO, the entire contents of which are hereby incorporated by reference.

### BACKGROUND

1. Technical Field

Example embodiments of the present invention relate to a method of operating a femto cell base-station, and more specifically, to a method of changing a service mode of a femto cell base-station operating as a closed service group (CSG) (or a closed subscriber group) cell or a hybrid cell, and a method of managing access allowed terminals.

2. Related Art

Recently, a home base-station such as a femto cell, which is a personal base-station installed indoors for serving one to four subscribers has been proposed. This home base-station is located in an area having a great radius of a macro base-station present outdoors. There are a large number of home base-stations in an urban environment.

Further, the home base-station has a CSG service mode in which service is allowed for only an individual user group but not allowed for other users, and a hybrid service mode in which service is partially allowed for the individual user group and the other users. A value of the mode set upon initial installation cannot be changed.

In the case of a CSG cell, a CSG ID is allocated to an individual user group, and users having the CSG ID are allowed to access a base station. This CSG ID is also initially set and cannot be changed.

For example, when neighbors or relatives visit a home where one home base-station is installed and the home base-station serves as a CSG cell, terminals of the neighbors or the relatives are not serviced by such a home base-station and perform communication using a macro base-station. Accordingly, serious interference occurs between the two base stations, and service quality may be degraded.

### SUMMARY

Accordingly, example embodiments of the present invention are provided to substantially obviate one or more problems due to limitations and disadvantages of the related art.

Example embodiments of the present invention provide a method capable of changing a service mode of a femto base-station using local area communication between a terminal and the femto base-station or using a user interface of the femto base-station in order to solve the aforementioned problems.

Example embodiments of the present invention also provide a method of managing access allowance for a terminal in a femto base-station using local area communication between a terminal and the femto base-station or using a user interface of the femto base-station in order to solve the aforementioned problems.

In some example embodiments, a method of changing a service mode of a femto base-station includes receiving a first service mode change request; transmitting a second service mode change request to a femto base-station management server in response to the first service mode change request; receiving an SIB (System Information Block) parameter changed in response to the second service mode change request from the femto base-station management server; and broadcasting system information generated based on the received SIB parameter.

Here, the first service mode change request may be received from the terminal through local area communication or from a user via a user interface included in the femto base-station.

Here, the first and second service mode change requests may be intended to change the service mode of the femto base-station from a closed service group (CSG) service mode to a hybrid service mode or from the hybrid service mode to the closed service group service mode.

Here, the changed SIB parameter may be a parameter of a field indicating the service mode in the system information.

Here, the method of changing a service mode of a femto base-station may further include notifying the terminal of service mode change completion through local area communication or notifying a user of the service mode change completion through a user interface.

In other example embodiments, a method of managing access allowance for a terminal in a femto base-station includes: receiving a first access allowance change request for the terminal; and transmitting a second access allowance change request for the terminal to a mobility management entity (MME) in response to the first access allowance change request.

Here, the method of managing access allowance for a terminal in a femto base-station may further include receiving a result of the second access allowance change request from the mobility management entity; and notifying of the result of the second access allowance change request. In this case, the terminal may be notified of the result of the second access allowance change request through local area communication or a user may be notified of the result of the second access allowance change request through a user interface included in the femto base-station.

Here, the first access allowance change request may be received from the terminal through local area communication or from a user via a user interface included in the femto base-station.

Here, the first access allowance change request may be a request to change the terminal to a terminal allowed to access the femto base-station or change the terminal to a terminal not allowed to access the femto base-station.

Here, the method of managing access allowance for a terminal in a femto base-station may further include receiving a request for a list of terminals allowed to access the femto base-station from the terminal through local area communication or from a user via a user interface; and providing the list of access allowed terminals to the terminal through the local area communication or to the user through the user interface.

According to the configuration of example embodiments of the present invention, it is possible for the mobile communication terminal of the user to change the service mode of the femto base-station while communicating with the femto base-station using a local area communication scheme or to manage access allowance for the terminal in the femto base-station. Further, it is possible for the user to change the service mode of the femto base-station using the user interface of the femto base-station or to manage access allowance for the terminal in the femto base-station.

As the method of changing the service mode or the access allowance for the terminal in real time according to a situation of the user is provided, the same frequency interference control between the macro base-station and the femto base-station can be achieved. Accordingly, quality of service can be improved and efficient management and use of the femto base-station can be achieved.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram illustrating an environment of a wireless communication system in which a femto base-station of an example embodiment of the present invention operates;

FIG. 2 is a block diagram illustrating a configuration of the femto base-station according to an example embodiment of the present invention and a configuration of a terminal interworking with the femto base-station;

FIG. 3 is a flowchart illustrating a method of changing a service mode of a femto base-station according to an example embodiment of the present invention;

FIG. 4 is a message flow diagram illustrating a method of changing a service mode of a femto base-station according to an example embodiment of the present invention;

FIG. 5 is a message flow diagram illustrating a method of changing a service mode of a femto base-station according to another example embodiment of the present invention;

FIG. 6 is a flowchart illustrating a method of managing access allowance for a terminal in a femto base-station according to an example embodiment of the present invention;

FIG. 7 is a message flow diagram illustrating a method of changing access allowance for a terminal in a femto base-station according to an example embodiment of the present invention; and

FIG. 8 is a message flow diagram illustrating a method of changing access allowance for a terminal in a femto base-station according to another example embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A “terminal” used in this disclosure may be referred to as a mobile station (MS), user equipment (UE), user terminal (UT), wireless terminal, access terminal (AT), terminal, subscriber unit, subscriber station (SS), wireless device, wireless communication device, wireless transmit/receive unit (WTRU), mobile node, mobile or the like. Various example embodiments of the terminal may include a cellular telephone, a smart phone having a wireless communication function, a personal digital assistant (PDA) having a wireless communication function, a wireless modem, a portable computer having a wireless communication function, a photographing device such as a digital camera having a wireless communication function, a gaming device having a wireless communication function, a music storage and playback appliance having a wireless communication function, an Internet appliance having wireless Internet accessing and browsing functions, and a portable unit or terminal having a combination of such functions, but are not limited thereto.

A “base station” used in this disclosure generally refers to a stationary or mobile point that communicates with a terminal. The base station may be referred to as node-B, eNode-B, a base transceiver system (BTS), an access point, a relay, a femto cell or the like.

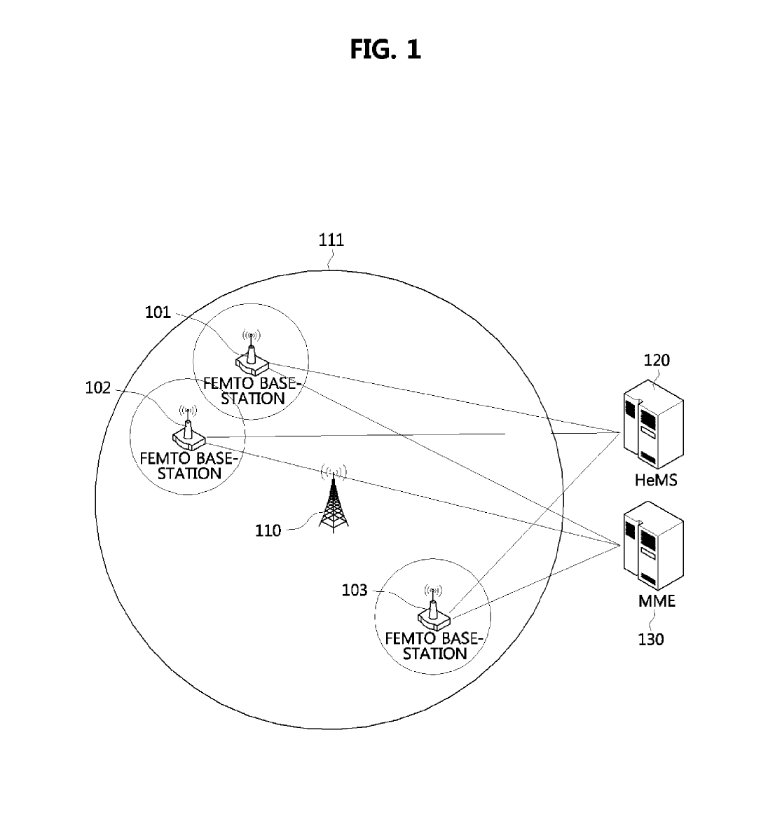

FIG. 1 is a conceptual diagram illustrating an environment of a wireless communication system in which a femto base-station of an example embodiment of the present invention operates.

Referring to FIG. 1, a number of femto base-stations 101, 102 and 103 are installed in such a manner that service areas of the femto base-stations overlap a service area 111 of a macro base-station 110. The femto base-stations and the macro base-station may use the same frequencies.

The femto base-stations are connected to a femto base-station management server (e.g., HeMS: HeNB Management System) 120 to perform functions necessary for operation and management of the femto base-stations. Further, in a network structure, a mobility management entity (MME; 130) that manages whether a terminal is allowed to access a base station is connected to the femto base-stations and the macro base-station.

### Femto Base-Station and Terminal Device According to Example Embodiment of the Present Invention

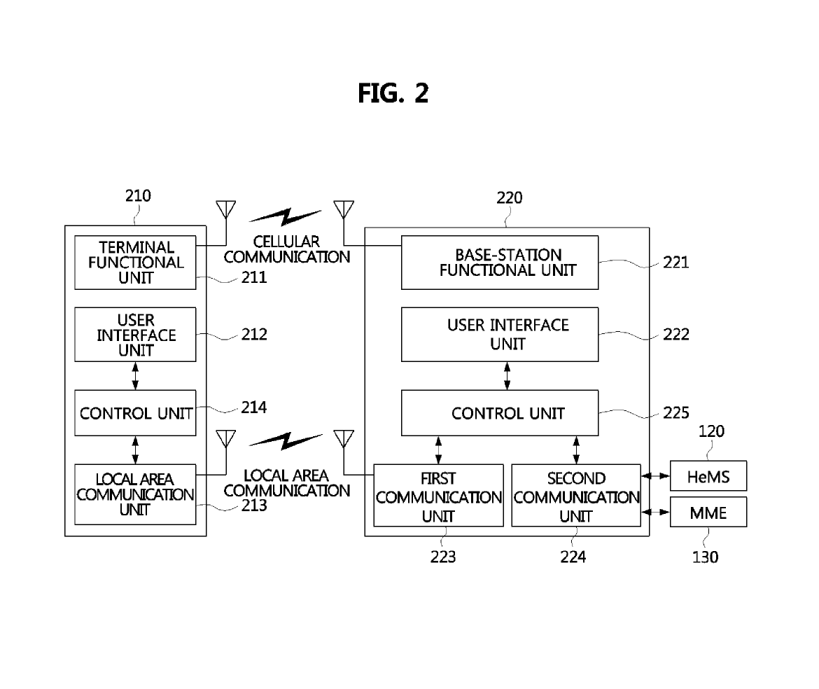

FIG. 2 is a block diagram illustrating a configuration of a femto base-station and a configuration of a terminal interworking with the femto base-station according to an example embodiment of the present invention.

Referring to FIG. 2, a mobile communication terminal 210 includes a terminal functional unit 211 that is responsible for basic functions of the mobile communication terminal.

Further, the mobile communication terminal 210 may include a user interface unit 212 that provides a function for enabling a user to select a menu for changing a service mode and registering or removing an access allowed terminal, a local area communication unit 213 that communicates with the femto base-station 220 using a local area communication method; and a control unit 214 that performs all application functions of an example embodiment of the present invention, as functional units added for the functions of an example embodiment of the present invention.

The femto base-station 220 includes a base-station functional unit 221 that is responsible for basic functions of the base station, similar to the terminal 210.

Further, the femto base-station 220 may include a first communication unit 223, a second communication unit 224, a control unit 225 and a user interface unit 222, as functional units added for the functions of an example embodiment of the present invention.

Here, the first communication unit 223 is a functional unit for performing communication with the local area communication unit of the terminal in a local area communication manner, and the second communication unit 224 is a functional unit for performing communication with the femto base-station management server (e.g., HeMS; 120) and/or the MME 130 described in FIG. 1. The second communication unit may be configured to connect the femto base-station to the femto base-station management server and/or the MME using a normal Internet network. An interface procedure, a message specification or the like between the femto base-station and the femto base-station management server and/or the MME are matters defined in standards and is not included in the scope of an example embodiment of the present invention. Accordingly, the second communication unit 224 may be a component included in the base-station functional unit 221 described above.

The femto base-station 220 may also include the user interface unit 222. The femto base-station may have two functional units of the first communication unit 223 and the user interface unit 222 or may have only one of the two functional units. This may depend on whether to configure the femto base-station 220 to receive a service mode change request (hereinafter referred to as a first service mode change request) or an access allowance change request (hereinafter referred to as a first access allowance change request) from the terminal via the first communication unit 223 or to receive the request from the user interface unit 222 in the method of changing a service mode or the method of managing terminal access allowance, which will be described below. When both of the functional units are included, the service mode change request or the access allowance change request can be selectively received from the terminal or from the user interface unit.

A method for local area communication between the local area communication unit 213 of the terminal and the first communication unit 223 of the femto base-station is not limited to a specific local area communication method and, for example, various communication methods such as Bluetooth communication, near field communication (NFC), ZigBee communication, WiFi communication, or infrared communication may be applied.

Further, a device such as a touch screen, a display, or a keypad usually included in the terminal may be used as the user interface unit 212 of the terminal. Generally, the femto base-station does not often include a user interface device such as a display or a keypad. However, if a user interface device not for an example embodiment of the present invention is already included, such a user interface device may operate as the user interface unit 222 of an example embodiment of the present invention. It is understood that a user interface device added to the femto base-station may be used as the user interface unit 222 for performing the object of an example embodiment of the present invention. For example, it is to be noted that functional units of the terminal and the femto base-station, which have been described above or will be described below, are defined according to functions performed by the respective functional units and do not mean physically independent devices.

The terminal functional unit 211 of the terminal and the base-station functional unit 221 of the femto base-station are not limited by an example embodiment of the present invention, and perform cellular communication based on a variety of mobile communication standards, including 2G/3G/4G.

The control unit 214 or 225 may include program code for performing the functions of an example embodiment of the present invention, a memory device on which the program code is loaded, and a processor capable of reading the program code from the memory device and executing the program code to control the user interface unit 212 or 222 and the communication unit 213 or 223 and 224 described above via an input/output (I/O) unit. Generally, since a processor and a memory device are also included in the terminal functional unit 211 of the terminal and the base-station functional unit 221 of the femto base-station, the processor and the memory device may be used to implement the control units 214 and 225. Alternatively, the control units 214 and 225 may be implemented by a dedicated processor or microcomputer, memory and the like to be able to perform the functions of an example embodiment of the present invention even when the terminal functional unit 211 and the base-station functional unit 221 described above do not operate.

In a method of changing a service mode and a method of managing access allowance for terminal, which will be described below, operations performed on the femto base-station side may be described as operations performed by the control unit 225 controlling the first communication unit 223 and the second communication unit 224 or controlling the second communication unit 224 and the user interface unit 222.

### Method of Changing Service Mode According to Example Embodiment of the Present Invention

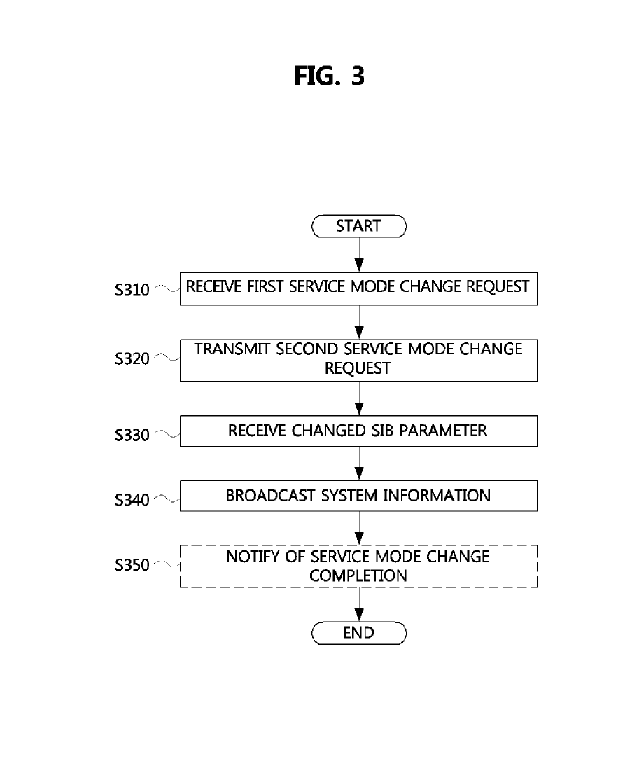

FIG. 3 is a flowchart illustrating a method of changing a service mode of a femto base-station according to an example embodiment of the present invention.

Referring to FIG. 3, a method of changing a service mode of a femto base-station according to an example embodiment of the present invention may include step S310 of receiving a first service mode change request, step S320 of transmitting a second service mode change request to the femto base-station management server, step S330 of receiving system information block (SIB) parameter changed in response to the second service mode change request, and step S340 of broadcasting system information generated based on the received system information block parameter.

Hereinafter, the “first service mode change request” means a message that the femto base-station receives from the terminal through local area communication or a request input from the user via the user interface unit. Further, the “second service mode change request” means a message that the femto base-station transmits to request the femto base-station management server (HeMS) to change the service mode.

Meanwhile, although not illustrated in FIG. 3, the method of changing a service mode may further include notifying the terminal of a current service mode of the femto base-station through local area communication or notifying (displaying) the user of the current service mode via the user interface unit. This allows the user to confirm the currently set service mode of the femto base-station and decides whether service mode change is to be required.

Step S310 of receiving the first service mode change request is a step in which the femto base-station receives the service mode change request from the terminal through local area communication or directly receives the service mode change request from the user through the user interface unit included in the femto base-station. For example, the femto base-station receives the service mode change request from the terminal via the first communication unit 223 of the femto base-station described with reference to FIG. 2, or directly receives the service mode change request from the user via the user interface unit 222.

In next step S320, the femto base-station transmits the second service mode change request to the femto base-station management server (e.g., HeMS) based on the first received service mode change request. The first service mode change request message and the second service mode change request message may have the same format and content. Accordingly, the femto base-station may be configured to simply deliver the first service mode change request message received from the terminal, as the second service mode change request message. Alternatively, the femto base-station may be configured to transmit, to the femto base-station management server, the second service mode change request message generated with a format and content that can be received by the femto base-station management server, based on the first service mode change request message.

In next step S330, the femto base-station receives system information block (SIB) parameter changed in response to the second service mode change request from the femto base-station management server. For example, a parameter of a CSG_Indication field that is a field indicating the service mode among SIB (System Information Broadcasting) parameters is set to “1” when the service mode requested by the femto base-station is CSG and “0” when the service mode is Hybrid, and is received from the femto base-station management server.

In next step S340, the femto base-station broadcasts system information generated based on the received SIB parameter. The terminal may receive the system information broadcast by the femto base-station and confirm the CSG_Indication field indicating the service mode to confirm the service mode of the femto base-station.

Meanwhile, the method of changing a service mode described above may further include step S350 of notifying, by the femto base-station, that the service mode change has been completed. As the system information on which the changed service mode has been reflected is broadcast in step S340, the terminal may receive the system information and recognize that the service mode has been changed. However, step S350 may be necessary in order to provide immediate feedback.

In step S350, the femto base-station may notify the terminal of service mode completion through local area communication (in this case, the terminal may display the service mode completion to the user through the user interface of the terminal) or may directly notify (display) the user of the service mode completion via the user interface unit included in the femto base-station.

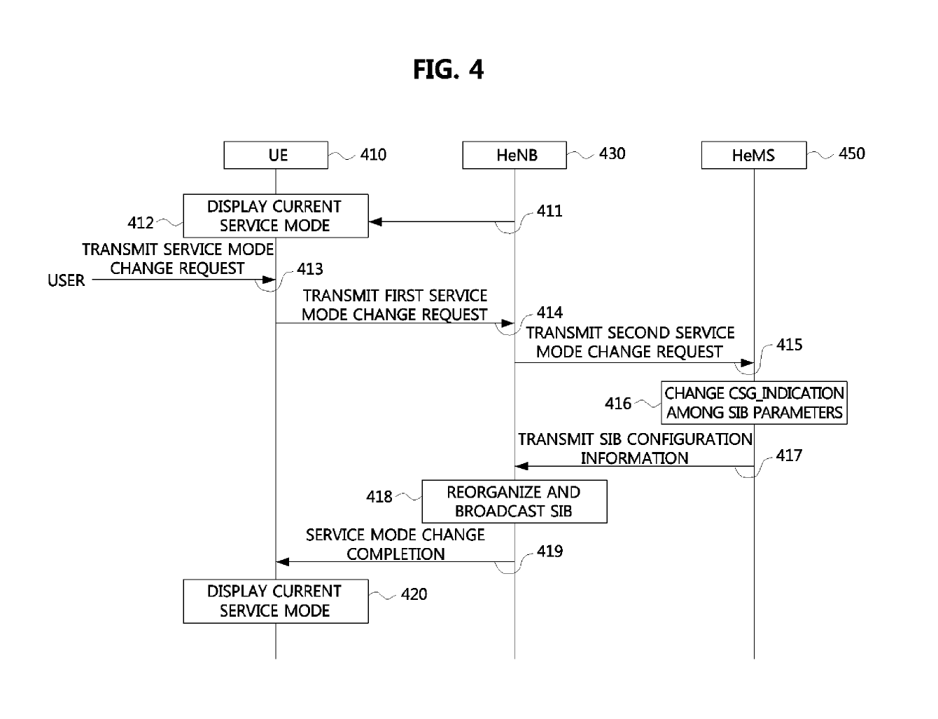

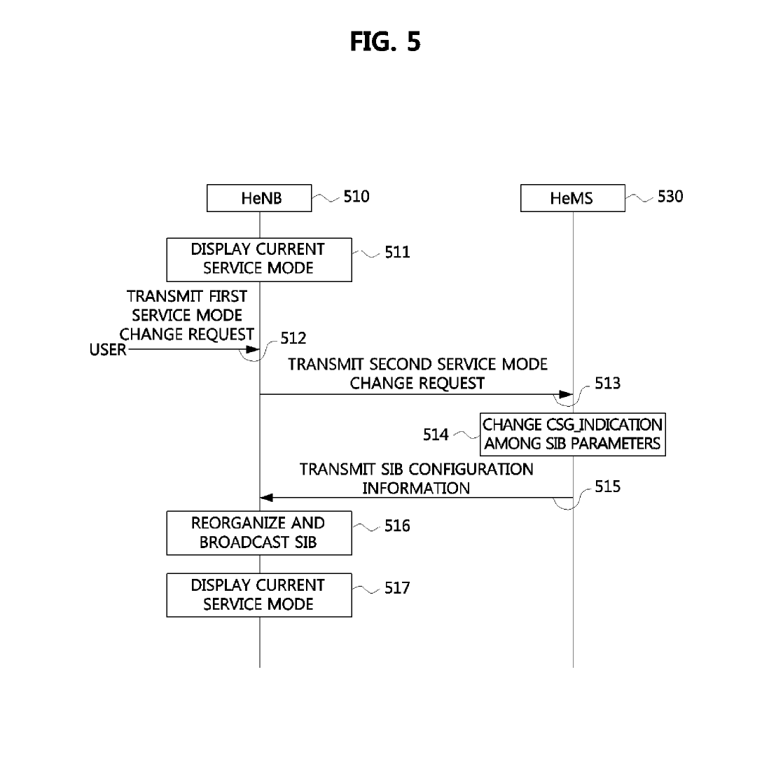

Hereinafter, the method of changing a service mode described above will be described in greater detail based on messages transmitted or received between the terminal, the femto base-station and the femto base-station management server and the operation of each entity. The service mode changing method illustrated in FIG. 4 is intended to describe a configuration in which the femto base-station performs the service mode change in response to the service mode change request from the terminal of the user. The service mode changing method illustrated in FIG. 5 is intended to describe a configuration in which the user directly manipulates the user interface unit of the femto base-station to request the femto base-station to change the service mode, and the femto base-station performs the service mode change.

FIG. 4 is a message flow diagram illustrating a method of changing a service mode of a femto base-station according to an example embodiment of the present invention.

The femto base-station 430 may notify the terminal 410 of a current service mode (CSG or hybrid) through local area communication (411). The terminal receiving the current service mode displays the current service mode to the user through the user interface unit of the terminal (412). The configuration for notifying the terminal of the current service mode of the femto base-station such that the user can confirm the current service mode is an optional configuration as described above, and is not necessarily required.

The user of the terminal inputs a desired service mode (CSG or hybrid) via the user interface unit of the terminal (413), and the control unit of the terminal transmits a first service mode change request message including the input service mode to the femto base-station through the local area communication unit (414).

The femto base-station receiving the first service mode change request message transmits a second service mode change request message to the HeMS 450 (415). The HeMS receiving the service mode changes request message changes a CSG_Indication parameter among SIB (System Information Broadcasting) parameters to “1” when the mode is CSG and “0’ when the mode is Hybrid (416), and transmits SIB information reorganized to include the changed CSG_Indication parameter to the femto base-station (417).

The femto base-station receiving the SIB configuration information reorganizes the SIB information and broadcasts the resultant SIB information within a cell (418).

Also, the femto base-station may transmit a service mode change completion message to the mobile communication terminal (419). The mobile communication terminal receiving the service mode change completion message may display the changed current service mode (CSG or Hybrid) through the user interface unit (420). The processes (419 and 420) may not be performed, as described above.

FIG. 5 is a message flow diagram illustrating a method of changing a service mode of a femto base-station according to another example embodiment of the present invention.

The femto base-station 510 may display a current service mode (CSG or hybrid) to the user through the user interface unit (511). The configuration for allowing the user to confirm the current service mode of the femto base-station is an optional configuration as described above, and may not necessarily required.

The user selects a desired service mode (CSG or Hybrid) through the user interface unit of the femto base-station to change the service mode of his or her femto base-station, and inputs a first service mode change request (512).

The control unit of the femto base-station transmits a second service mode change request including the input service mode to the HeMS (513).

The HeMS receiving the second service mode change request message changes a CSG_Indication parameter of SIB (System Information Broadcasting) parameters to “1” when the mode is CSG and “0” when the mode is Hybrid (514), and transmits SIB information reorganized to include the changed CSG_Indication parameter to the femto base-station (515).

The femto base-station receiving the SIB configuration information reorganizes the SIB information and broadcasts the resultant SIB information within the cell (516). The femto base-station outputs the changed current service mode (CSG or Hybrid) to the user via the user interface unit (517). The process 517 may not be performed, as described above.

### Method of Managing Allowed Terminals According to an Example Embodiment of the Present Invention

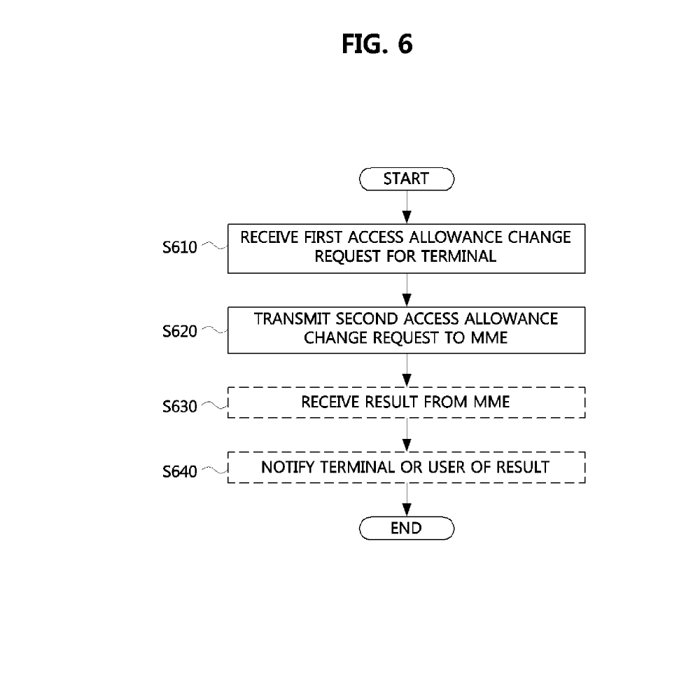

FIG. 6 is a flowchart illustrating a method of managing access allowance for a terminal in a femto base-station according to an example embodiment of the present invention.

Referring to FIG. 6, the method of managing access allowance according to an example embodiment of the present invention may include a step S610 of receiving a first access allowance change request for a terminal, and a step S620 of transmitting a second access allowance change request for a terminal to the mobility management entity (MME) in response to the first access allowance change request. Meanwhile, here, a target terminal making a request for an access allowance change may be a terminal transmitting the first access allowance change request to the femto base-station or may be a third terminal.

Hereinafter, the “first access allowance change request” refers to a message that the femto base-station receives from the terminal through local area communication or a request input from the user via the user interface unit. Further, the “second access allowance change request” refers to a message that the femto base-station transmits to the MME in order to make a request for access allowance change for a terminal. Further, the first access allowance change request and the second access allowance change request refer to a request for changing a terminal to a terminal allowed to access the femto base-station (i.e., registering the terminal in an allowed terminal list of the femto base-station) or for changing the terminal to a terminal not allowed to access the femto base-station (i.e., deleting the terminal from the allowed terminal list of the femto base-station).

Meanwhile, although not shown in FIG. 6, the method of managing access allowance may further include a step of notifying the terminal of a list of terminals allowed to access the femto base-station through local area communication or notifying (displaying) the user of the list through the user interface. This allows the user to confirm the access allowed terminals currently registered in the femto base-station and decides whether the access allowance change for the terminal (his or her terminal or a third terminal) is to be requested. In this case, a request for the allowed terminal list may be received from the terminal through local area communication or may be input from the user via the user interface unit of the femto base-station.

First, in step S610, the femto base-station may receive the first access allowance change request for a terminal from the terminal through local area communication or may directly receive the first access allowance change request from the user through the user interface unit included in the femto base-station. For example, the femto base-station receives the access allowance change request for a terminal from the terminal via the first communication unit 223 of the femto base-station described with reference to FIG. 2 or directly receives the access allowance change request from the user via the user interface unit 222.

In next step S620, the femto base-station transmits a second access allowance change request to the mobility management entity (e.g., MME) based on the first received access allowance change request. The first access allowance change request message and the second access allowance change request message may have the same format and content or may have a different format and content.

In next step S630, the femto base-station receives a result of the second access allowance change request from the MME. In other words, the MME performs a procedure of registering the target terminal in the access allowed terminal list of the target femto base-station or deleting the target terminal from the access allowed terminal list in response to the second access allowance change, and notifies the femto base-station of a result thereof (registration completion or deletion completion). In next step S640, the femto base-station may notify the terminal of the result received from the MME using local area communication or directly notify the user of the result using the user interface unit. Steps S630 and S640 are optional steps, as described above, and may not be performed.

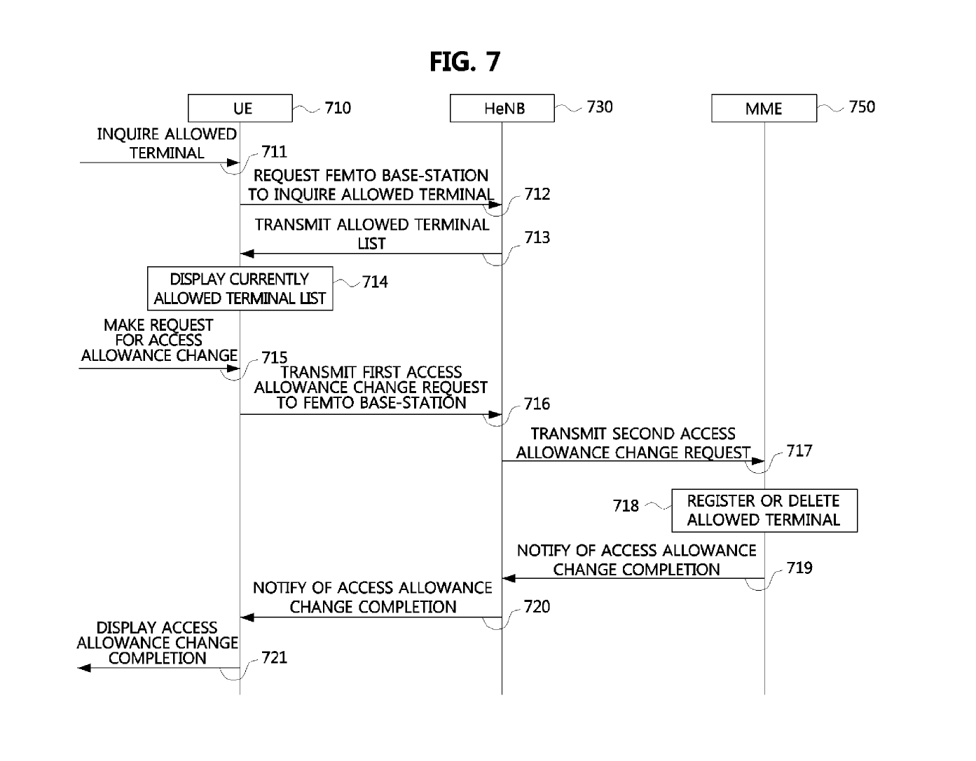

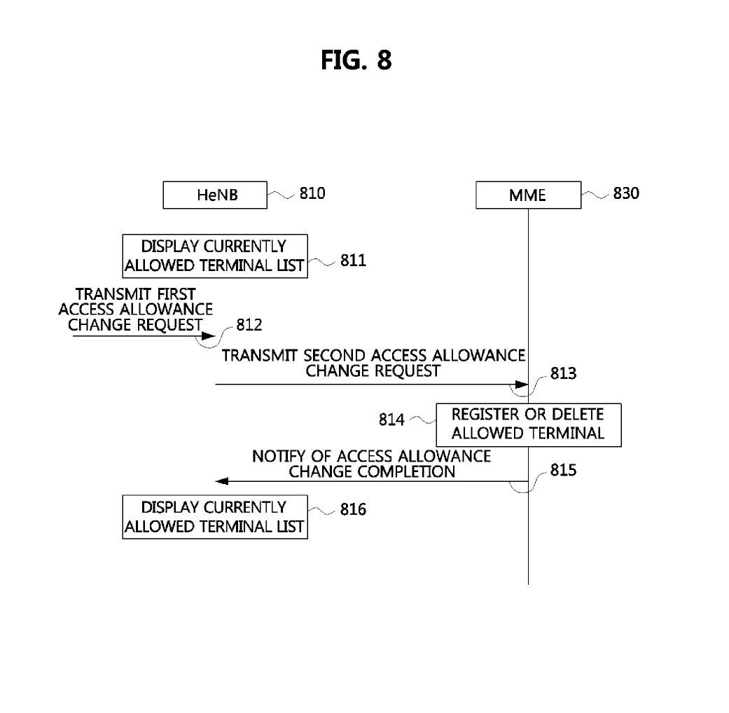

Hereinafter, the method of managing access allowance for a terminal described above will be described in detail based on messages transmitted or received between the terminal, the femto base-station and the mobility management entity and the operation of each entity. The method illustrated in FIG. 7 is intended to describe a configuration in which the femto base-station performs the access allowance change request in response to the access allowance change request from the terminal of the user. The method illustrated in FIG. 8 is intended to describe a configuration in which the user directly manipulates the user interface unit of the femto base-station to make an access allowance change request and the femto base-station performs the change.

FIG. 7 is a message flow diagram illustrating a method of changing access allowance for a terminal in a femto base-station according to an example embodiment of the present invention.

Referring to FIG. 7, the terminal 710 may receive a request to inquire an access allowed terminal list from the user (711), and request the femto base-station 730 to inquire the access allowed terminal list (712) through the local area communication. The femto base-station transmits a list of currently registered allowed terminals to the terminal (713), and the terminal displays the list of currently registered allowed terminals to the user through the user interface (714).

The procedure (711 to 714) described above is an optional configuration as described above, and may not necessarily required and the process may proceed to the following procedure (715).

In order to register a new mobile terminal or delete an access allowed terminal, the user inputs terminal information using an allowed terminal registration (or allowed terminal deletion) menu through the user interface unit of the mobile communication terminal to make a request for access allowance change (715).

The control unit of the mobile communication terminal transmits a first access allowance change request message including the input information (an allowed terminal registration request message or an allowed terminal deletion request message) to the femto base-station via the local area communication unit (716).

The control unit of the femto base-station receiving the first access allowance change request message transmits a second access allowance change request message based on the first access allowance change request message to the MME (717). The MME receiving the second access allowance change request message registers the new terminal in the allowed terminal list of the femto base-station or deletes the target terminal from the allowed terminal list (718), and transmits an access allowance change completion message (to notify of registration completion or deletion completion) to the femto base-station (719).

The control unit of the femto base-station receiving the access allowance change completion message from the MME transmits the access allowance change completion message to the mobile communication terminal via the local area communication unit (720). The mobile communication terminal receiving the access allowance change completion message from the femto base-station notifies the user of allowed terminal registration (or deletion) completion through the user interface (721). The procedure (719 to 721) is an optional procedure as described above, and may not be performed.

FIG. 8 is a message flow diagram illustrating a method of changing access allowance for a terminal in a femto base-station according to another example embodiment of the present invention.

Referring to FIG. 8, the femto base-station 810 may display a list of currently access allowed terminals to the user through the user interface unit (811). The user may confirm the access allowed terminals currently registered in the femto base-station through the procedure (811), and decide whether a change of access allowance for his or her terminal is to be requested. However, the procedure (811) is an optional procedure and some users may directly proceed to the following procedure (812) without inquiring the currently registered allowed terminals.

In order to register a new mobile terminal or delete an access allowed terminal, the user inputs terminal information using an allowed terminal registration (allowed terminal deletion) menu through the user interface of the femto base-station to input a first access allowance change request (a request to register a target terminal in the allowed terminal list or delete the target terminal from the access allowed terminal list) (812).

The control unit of the femto base-station transmits a second access allowance change request based on the first access allowance change request to the MME (813). The MME receiving the second access allowance change request registers the terminal in the allowed terminal list of the femto cell or deletes the terminal from the allowed terminal list of the femto cell (814). The MME then transmits an access allowance change completion message (to notify of registration completion or deletion completion) to the femto base-station (815). The femto base-station may display the registration completion or the deletion completion based on the received access allowance change completion message to the user through the user interface unit (816). The procedure (816 and 817) is an optional procedure as described above, and may not be performed.

While the example embodiments of the present invention and their advantages have been described in detail, it should be understood that various changes, substitutions and alterations may be made herein without departing from the scope of the invention.

What is claimed is:

1. A method of changing a service mode of a femto base-station, the method comprising:
receiving a first service mode change request;
transmitting a second service mode change request to a femto base-station management server in response to the first service mode change request;
receiving an SIB (System Information Block) parameter changed in response to the second service mode change request from the femto base-station management server; and
broadcasting system information generated based on the received SIB parameter.

2. The method according to claim 1, wherein the first service mode change request is received from the terminal through local area communication or from a user via a user interface included in the femto base-station.

3. The method according to claim 1, wherein the first and second service mode change requests are intended to change the service mode of the femto base-station from a closed service group (CSG) service mode to a hybrid service mode or from the hybrid service mode to the closed service group service mode.

4. The method according to claim 1, wherein the changed SIB parameter is a parameter of a field indicating the service mode in the system information.

5. The method according to claim 1, further comprising: notifying the terminal of service mode change completion through local area communication or notifying a user of the service mode change completion through a user interface.

6. The method according to claim 1, further comprising: notifying the terminal of a current service mode of the femto base-station through local area communication or notifying a user of the current service mode of the femto base-station via a user interface.

7. A method of managing access allowance for a terminal in a femto base-station, the method comprising:
receiving a first access allowance change request for the terminal; and
transmitting a second access allowance change request for the terminal to a mobility management entity (MME) in response to the first access allowance change request.

8. The method according to claim 7, further comprising:
receiving a result of the second access allowance change request from the mobility management entity; and
notifying of the result of the second access allowance change request.

9. The method according to claim 7, wherein the first access allowance change request is received from the terminal through local area communication or from a user via a user interface included in the femto base-station.

10. The method according to claim 7, wherein the first access allowance change request is a request to change the terminal to a terminal allowed to access the femto base-station or change the terminal to a terminal not allowed to access the femto base-station.

11. The method according to claim 8, comprising: notifying the terminal of the result of the second access allowance change request through local area communication or notifying a user of the result of the second access allowance change request through a user interface included in the femto base-station.

12. The method according to claim 7, further comprising:
receiving a request for a list of terminals allowed to access the femto base-station from the terminal through local area communication or from a user via a user interface; and
providing the list of access allowed terminals to the terminal through the local area communication or to the user through the user interface.
